(19) United States
(12) Patent Application Publication
(10) Pub. No.: US 2022/0108126 A1
(43) Pub. Date: Apr. 7, 2022

(54) CLASSIFYING DOCUMENTS BASED ON TEXT ANALYSIS AND MACHINE LEARNING

(71) Applicant: International Business Machines Corporation, Armonk, NY (US)

(72) Inventors: Dieter Hans Schieber, Jettingen (DE); Holger Koenig, Boeblingen (DE); Hemanth Kumar Babu, Boeblingen (DE); Peter Gerstl, Holzgerlingen (DE); Werner Schuetz, Nufringen (DE); Robert Kern, Karlsruhe (DE); Lars Bremer, Boeblingen (DE); Michael Baessler, Bempflingen (DE)

(21) Appl. No.: 17/064,623

(22) Filed: Oct. 7, 2020

(51) Int. Cl. G06K 9/62; G06K 9/00; G06F 40/10; G06F 16/93; G06N 20/00

(52) U.S. Cl. CPC G06K 9/6231; G06K 9/00442; G06N 20/00; G06K 9/6262; G06F 16/93; G06F 40/10

(57) ABSTRACT

A computer device identifies a set of documents for classification. The computing device classifies documents of a first subset of the set of documents based, at least in part, on a text analysis of the documents of the first subset. The computing device trains a document classifier using, as training data: (i) results of the classifying of the documents of the first subset, and (ii) metadata associated with the documents of the first subset. The computing device classifies documents of a second subset of the set of documents by providing metadata of the documents of the second subset to the trained document classifier.

### BACKGROUND OF THE INVENTION

The present invention relates generally to the field of data classification, and more particularly to classification of large sets of unclassified documents.

Generally, data classification is the process of analyzing data and organizing the data into groups based on, at least, file type, contents, and other metadata. Data classification allows organizations to mitigate risks and governance policies associated with their internal data.

### SUMMARY

Embodiments of the present invention provide a method, system, and program product.

A first embodiment encompasses a method. One or more processors identify a set of documents for classification. The one or more processors classify documents of a first subset of the set of documents based, at least in part, on a text analysis of the documents of the first subset. The one or more processors train a document classifier using, as training data: (i) results of the classifying of the documents of the first subset, and (ii) metadata associated with the documents of the first subset. The one or more processors classify documents of a second subset of the set of documents by providing metadata of the documents of the second subset to the trained document classifier.

A second embodiment encompasses a computer program product. The computer program product includes one or more computer-readable storage media and program instructions stored on the one or more computer-readable storage media. The program instructions include program instructions to identify a set of documents for classification. The program instructions include program instructions to classify documents of a first subset of the set of documents based, at least in part, on a text analysis of the documents of the first subset. The program instructions include program instructions to train a document classifier using, as training data: (i) results of the classifying of the documents of the first subset, and (ii) metadata associated with the documents of the first subset. The program instructions include program instructions to classify documents of a second subset of the set of documents by providing metadata of the documents of the second subset to the trained document classifier.

A third embodiment encompasses a computer system. The computer system includes one or more computer processors, one or more computer-readable storage media, and program instructions stored on the computer-readable storage media for execution by at least one of the one or more processors. The program instructions include program instructions to identify a set of documents for classification. The program instructions include program instructions to classify documents of a first subset of the set of documents based, at least in part, on a text analysis of the documents of the first subset. The program instructions include program instructions to train a document classifier using, as training data: (i) results of the classifying of the documents of the first subset, and (ii) metadata associated with the documents of the first subset. The program instructions include program instructions to classify documents of a second subset of the set of documents by providing metadata of the documents of the second subset to the trained document classifier.

### BRIEF DESCRIPTION OF THE SEVERAL VIEWS OF THE DRAWINGS

FIG. 1 is a functional block diagram illustrating a computing environment, in which a computing device generates a document classifier based on, at least, metadata, in accordance with an exemplary embodiment of the present invention.

FIG. 2 illustrates operational processes of executing a system for generating a document classifier for classification of digital documents based on, at least, metadata, on a computing device within the environment of FIG. 1, in accordance with an exemplary embodiment of the present invention.

FIG. 3 depicts a cloud computing environment according to at least one embodiment of the present invention.

FIG. 4 depicts abstraction model layers according to at least one embodiment of the present invention.

FIG. 5 depicts a block diagram of components of one or more computing devices within the computing environment depicted in FIG. 1, in accordance with an exemplary embodiment of the present invention.

### DETAILED DESCRIPTION

Detailed embodiments of the present invention are disclosed herein with reference to the accompanying drawings. It is to be understood that the disclosed embodiments are merely illustrative of potential embodiments of the present invention and may take various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the present invention provide a technological improvement over known solutions for document classification, and, more specifically, to systems for classifying large sets of documents so that the documents can be more easily identified for organizations. For example, embodiments of the present invention classify a first subset of a total set of unclassified documents based on a full-text analysis. Based on the classification of the first subset, embodiments of the present invention then classify the totality of the remaining documents (a “second subset”) based on the metadata of the remaining documents, as opposed to a full-text analysis.

Embodiments of the present invention provide servers and systems that improve over conventional systems by providing a more efficient classification of unclassified documents, thereby reducing overall load on the system. Embodiments of the present invention recognize that a system would see a decrease in load because the system would utilize less processing power and would provide users a more comprehensive overview of the organization's unclassified documents, thus reducing the amount of time the user spends on the system searching/reviewing all of the unclassified documents, which again, reduces overall system load. Additionally, embodiments of the present invention provide servers and systems that improve over conventional system by providing a more efficient review of unclassified documents, thereby reducing overall resource consumption for classifying and reducing load on the system hosting the documents themselves. Embodiments of the present invention recognize that the system would see a decrease in resource consumption because the system would utilize less processing power.

The present invention will now be described in detail with reference to the Figures.

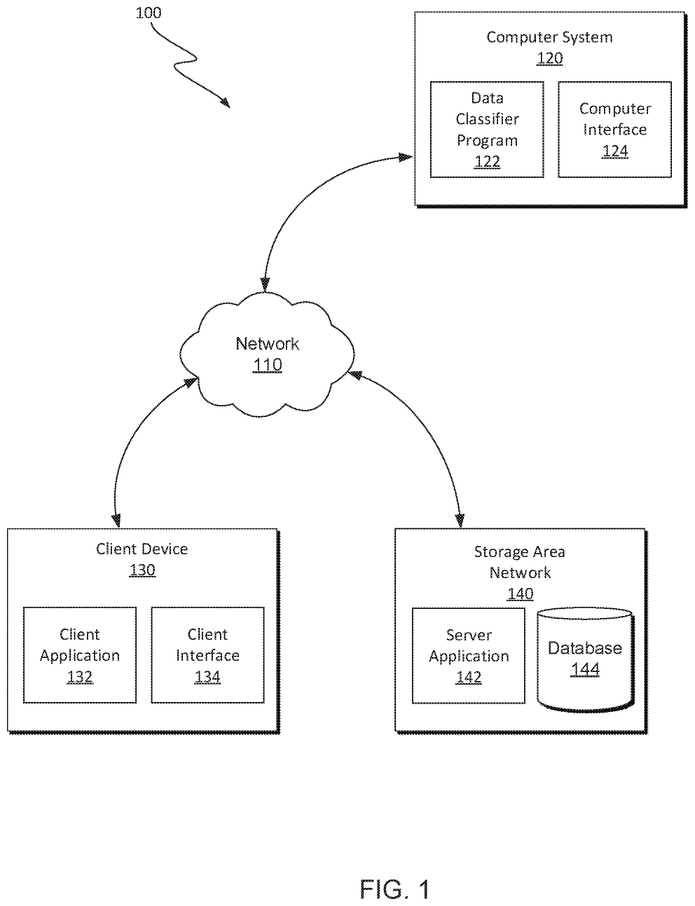

FIG. 1 is a functional block diagram illustrating computing environment, generally designated 100, in accordance with one embodiment of the present invention. Computing environment 100 includes computer system 120, client device 130, and storage area network (SAN) 140 connected over network 110. Computer system 120 includes data classifier program 122 and computer interface 124. Client device 130 includes client application 132 and client interface 134. Storage area network 140 includes server application 142 and database 144. Embodiments of the present invention provide, as used herein, that the term “or” is an inclusive or; for example A, B, “or” C means that at least one of A or B or C is true and applicable.

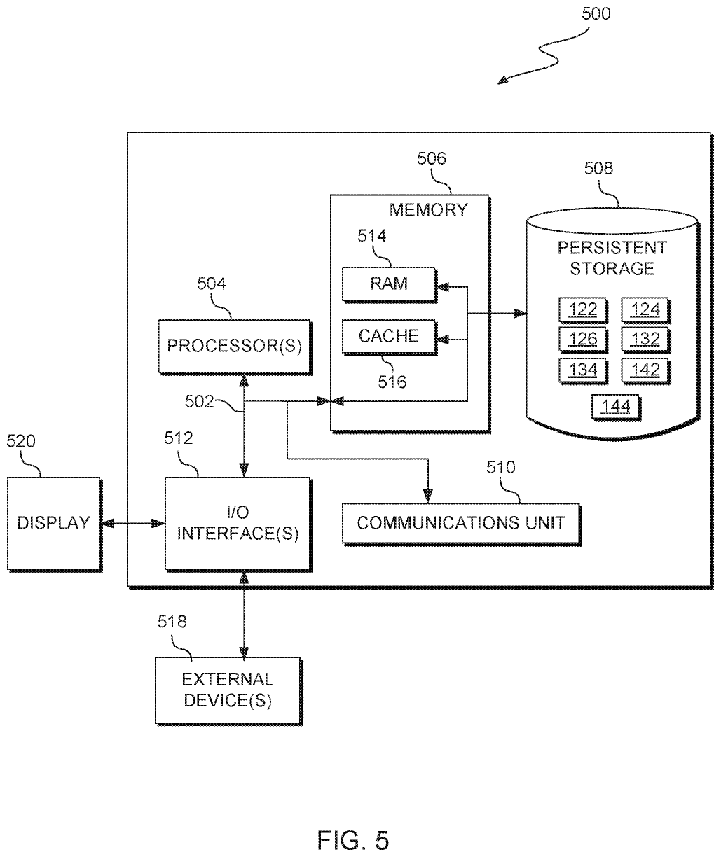

In various embodiments of the present invention, computer system 120 is a computing device that can be a standalone device, a server, a laptop computer, a tablet computer, a netbook computer, a personal computer (PC), a personal digital assistant (PDA), a desktop computer, or any programmable electronic device capable of receiving, sending, and processing data. In general, computer system 120 represents any programmable electronic device or combination of programmable electronic devices capable of executing machine readable program instructions and communications with various other computer systems (not shown). In another embodiment, computer system 120 represents a computing system utilizing clustered computers and components to act as a single pool of seamless resources. In general, computer system 120 can be any computing device or a combination of devices with access to various other computing systems (not shown) and is capable of executing data classifier program 122 and computer interface 124. Computer system 120 may include internal and external hardware components, as described in further detail with respect to FIG. 5.

In this exemplary embodiment, data classifier program 122 and computer interface 124 are stored on computer system 120. However, in other embodiments, data classifier program 122 and computer interface 124 are stored externally and accessed through a communication network, such as network 110. Network 110 can be, for example, a local area network (LAN), a wide area network (WAN) such as the Internet, or a combination of the two, and may include wired, wireless, fiber optic or any other connection known in the art. In general, network 110 can be any combination of connections and protocols that will support communications between computer system 120, client device 130, and SAN 140, and various other computer systems (not shown), in accordance with desired embodiment of the present invention.

In the embodiment depicted in FIG. 1, data classifier program 122, at least in part, has access to client application 132 and can communicate data stored on computer system 120 to client device 130, SAN 140, and various other computer systems (not shown). More specifically, data classifier program 122 defines a user of computer system 120 that has access to data stored on client device 130 and/or database 144.

Data classifier program 122 is depicted in FIG. 1 for illustrative simplicity. In various embodiments of the present invention, data classifier program 122 represents logical operations executing on computer system 120, where computer interface 124 manages the ability to view these logical operations that are managed and executed in accordance with data classifier program 122. In some embodiments, data classifier program 122 represents a cognitive AI system that processes and analyzes data of unclassified documents. Additionally, data classifier program 122, when executing data analysis, operates to derive data from a digital document and classify the digital document based on, at least, the document classifier (i.e., cognitive AI system).

Computer system 120 includes computer interface 124. Computer interface 124 provides an interface between computer system 120, client device 130, and SAN 140. In some embodiments, computer interface 124 can be a graphical user interface (GUI) or a web user interface (WUI) and can display, text, document, web browsers, windows, user options, application interfaces, and instructions for operation, and includes the information (such as graphic, text, and sound) that a program presents to a user and the control sequences the user employs to control the program. In some embodiments, computer system 120 accesses data communicated from client device 130 and/or SAN 140 via a client-based application that runs on computer system 120. For example, computer system 120 includes mobile application software that provides an interface between computer system 120, client device 130, and SAN 140. In various embodiments, computer system 120 communicates the GUI or WUI to client device 130 for instruction and use by a user of client device 130.

In various embodiments, client device 130 is a computing device that can be a standalone device, a server, a laptop computer, a tablet computer, a netbook computer, a personal computer (PC), a personal digital assistant (PDA), a desktop computer, or any programmable electronic device capable of receiving, sending and processing data. In general, computer system 120 represents any programmable electronic device or combination of programmable electronic devices capable of executing machine readable program instructions and communications with various other computer systems (not shown). In another embodiment, computer system 120 represents a computing system utilizing clustered computers and components to act as a single pool of seamless resources. In general, computer system 120 can be any computing device or a combination of devices with access to various other computing systems (not shown) and is capable of executing client application 132 and client interface 134. Client device 130 may include internal and external hardware components, as described in further detail with respect to FIG. 5.

Client application 132 is depicted in FIG. 1 for illustrative simplicity. In various embodiments of the present invention client application 132 represents logical operations executing on client device 130, where client interface 134 manages the ability to view these various embodiments, client application 132 defines a user of client device 130 that has access to data stored on computer system 120 and/or database 144.

Storage area network (SAN) 140 is a storage system that includes server application 142 and database 144. SAN 140 may include one or more, but is not limited to, computing devices, servers, server-clusters, web-servers, databases and storage devices. SAN 140 operates to communicate with computer system 120, client device 130, and various other computing devices (not shown) over a network, such as network 110. For example, SAN 140 communicates with data classifier program 122 to transfer data between computer system 120, client device 130, and various other computing devices (not shown) that are not connected to network 110. SAN 140 can be any computing device or a combination of devices that are communicatively connected to a local IoT network, i.e., a network comprised of various computing devices including, but are not limited to computer system 120 and client device 130, to provide the functionality described herein. SAN 140 can include internal and external hardware components as described with respect to FIG. 5. The present invention recognizes that FIG. 1 may include any number of computing devices, servers, databases, and/or storage devices, and the present invention is not limited to only what is depicted in FIG. 1. As such, in some embodiments some of the features of computer system 120 are included as part of SAN 140 and/or another computing device.

Additionally, in some embodiments, SAN 140 and computer system 120 represent, or are part of, a cloud computing platform. Cloud computing is a model or service deliver for enabling convenient, on demand network access to a shared pool of configurable computing resources (e.g., networks, network bandwidth, servers, processing, memory, storage, applications, virtual machines, and service(s) that can be rapidly provisioned and released with minimal management effort or interaction with a provider of a service. A cloud model may include characteristics such as on-demand self-service, broad network access, resource pooling, rapid elasticity, and measured service, can be represented by service models including a platform as a service (PaaS) model, an infrastructure as a service (IaaS) model, and a software as a service (SaaS) model, and ca be implemented as various deployment models as a private cloud, a community cloud, a public cloud, and a hybrid cloud. In various embodiments, SAN 140 represents a database or website that includes, but is not limited to, data associated with weather patterns.

SAN 140 and computer system 120 are depicted in FIG. 1 for illustrative simplicity. However, it is to be understood that, in various embodiments, SAN 140 and computer system 120 can include any number of databases that are managed in accordance with the functionality of data classifier program 122 and server application 142. In general, database 144 represents data and server application 142 represents code that provides an ability to use and modify the data. In an alternative embodiment, data classifier program 122 can also represent any combination of the aforementioned features, in which server application 142 has access to database 144. To illustrate various aspects of the present invention, examples of server application 142 are presented in which data classifier program 122 represents one or more of, but is not limited to, data classification based on, at least, metadata.

In some embodiments, server application 142 and database 144 are stored on SAN 140. However, in various embodiments, server application 142 and database 144 may be stored externally and accessed through a communication network, such as network 110, as discussed above.

In various embodiments of the present invention, a user of client device 130 generates a request for data classification of the digital documents (e.g., the totality of the unclassified documents) stored on database 144, utilizing, at least, client application 132. In various embodiments, client application 132 detects a data classifier request occurs, and exit criteria have been established. In various embodiments of the present invention, client application 132 communicates the data classifier request to data classifier program 122.

In various embodiments, data classifier program 122 receives the data classifier request from client application 132. Data classifier program 122 analyzes the data classifier request and identifies (i) pre-existing metadata of the unclassified documents, and (ii) derived metadata of the unclassified documents. In various embodiments, the pre-existing metadata includes metadata that already exists for the documents, such as document owner, file type, source, folder, and the like. In various embodiments, the derived metadata includes metadata that can be derived from the pre-existing metadata, such as department of the document owner and country of origin, for example.

Embodiments of the present invention provide for an in-depth text analysis of a first subset of unclassified documents (e.g., a small representative subset of the totality of the unclassified documents that are analyzed by a full text classification), wherein data classifier program 122 classifies the first subset of the unclassified documents. In various embodiments, data classifier program 122 generates a document classifier based on the classification derived from the in-depth text analysis, wherein the document classifier is trained and classifies documents (such as a second subset of documents) according to their metadata (pre-existing and derived) as opposed to an in-depth text analysis. In various embodiments, data classifier program 122 runs a new in-depth text analysis (e.g., using natural language processing) of a new first subset of unclassified documents and also executes the document classifier on the new first subset. Data classifier program 122 then compares the results of the document classifier against the new in-depth text analysis. In various embodiments, data classifier program 122 calculates the precision and/or recall of the document classifier based on, at least, the assumption that the new in-depth text analysis produced results of 100% accuracy (or close to 100% accuracy). In various embodiments, data classifier program 122 continues the iterative process, as discussed above, until an exit criterion has been reached (e.g., where no significant improvement in the precision/recall has occurred, or where the process has reached a maximum number of iterative cycles).

Embodiments of the present invention recognize that a large number of the second subset of the unclassified documents can be efficiently classified based on, at least, available metadata without requiring a comprehensive text analysis of the content contained within the documents themselves. Embodiments of the present invention further recognize that classifying the totality of the unclassified documents without a comprehensive text analysis of the content contained within the totality of the unclassified documents is achieved by training a metadata-based cognitive AI classifier based, at least in part, on subsets of the unclassified documents for which a comprehensive text analysis has been performed. Embodiments of the present invention provide that a small threshold amount of the totality of the unclassified documents must be analyzed to allow the content of the totality of the unclassified documents to be classified by the document classifier.

Embodiments of the present invention recognize that, in many cases, the precision of the in-depth text analysis must be very high, with a high threshold level of confidence, to be considered reliable. For example, the in-depth text analysis may include supervised manual inspection or programmatic identification of document features which can be identified with high precision including, for example: (i) credit card numbers, (ii) bank account numbers (such as IBANs), and/or (iii) documents that contain more than a certain number of email addresses.

In one example embodiment, computer system 120 is operated by an organization that includes policies and regulations for users (e.g., a user of client device 130) within the organization. In this example embodiment, the policies and regulations provide that sensitive and personal identifying information (PII) cannot be stored within cloud data sources (e.g., SAN 140). In this example embodiment, an authorized user of computer system 120 wishes to locate and remove digital documents that contain PII that are stored on database 144 of SAN 140. In this example embodiment, 100,000 users (e.g., the user of client device 130) are within the organization and 200 unique unclassified documents exist for each individual user, wherein a total of 20,000,000 unclassified documents are stored on database 144. The present embodiment recognizes that to perform text analytics against each individual document of the 20,000,000 unclassified documents is costly to the organization and is inefficient.

Continuing the example embodiment, to identify the PII contained within the totality of the unclassified documents stored on database 144, data classifier program 122 generates a document classifier for analyzing the unclassified documents. First, data classifier program 122 runs a full-text analysis on a first subset of unclassified documents, containing 1,000 unclassified documents, and identifies PII data within the first subset. Then, data classifier program 122 identifies the associated metadata of the documents within the first subset that contain PII and uses the identified metadata to train the document classifier to identify documents containing PII based on the associated metadata of the documents. Then, in this example embodiment, data classifier program 122 runs a new in-depth text analysis (e.g., using natural language processing) of a new first subset of unclassified documents, containing 1,000 unclassified documents, and also executes the document classifier on the new first subset. Data classifier program 122 then compares the results of the document classifier against the new in-depth text analysis. In this example embodiment, data classifier program 122 calculates the precision and/or recall of the document classifier based on, at least, the assumption that the new in-depth text analysis produced results of 100% accuracy (or close to 100% accuracy). In this example embodiment, data classifier program 122 continues the iterative process, as discussed above, until an exit criterion has been reached (e.g., where no significant improvement in the precision/recall has occurred, or where the process has reached a maximum number of iterative cycles). In this example, the iterative process continues for four (4) iterations, covering four (4) new first subsets of 1,000 documents each.

In this example embodiment, once the iterative process is complete, data classifier program 122 uses the trained data classifier to analyze the metadata of the remaining unclassified 19,995,000 documents of the original 20,000,000 unclassified documents (a “second subset”). In this example embodiment, the trained data classifier analyzes the pre-existing metadata of the second subset that includes, but is not limited to, (i) creator name, (ii) creation date, (iii) folder name, (iv) file type. In this example embodiment, the trained data classifier also analyzes the derived metadata of the second subset that includes, but is not limited to, (i) department of the document owner and (ii) country of origin. As a result, data classifier program 122 identifies documents of the second subset that contain PII data based on, at least, the analyzation of the metadata of the second subset by the trained data classifier.

In this example embodiment, data classifier program 122 utilizes the document classifier to analyze the 20,000,000 unclassified document for PII and data classifier program 122 identifies unclassified documents that contain PII. In this example embodiment, data classifier program 122 identifies subsets of unclassified documents that contain PII. Embodiments of the present invention provide that subsets of unclassified documents that contain PII represent groupings of unclassified documents with similar metadata (e.g., metadata from a country of origin, a group or individual within the organization, etc.). In response to identifying subsets of unclassified documents that contain PII (i.e., documents that data classifier program 122 identifies as non-compliant), data classifier program 122 remediates the PII from the unclassified documents that contain PII from the cloud-based system. In alternative embodiments, data classifier program 122 includes program instructions that include, but are not limited to, (i) to purge entire groups of unclassified documents based on whether a threshold value of documents within the group contain PII, (ii) move entire groups of unclassified documents to a save location, or (iii) inform document owners that their unclassified documents contain PII. In alternative embodiments, if data classifier program 122 identifies that a grouping of unclassified documents reaches a threshold value (i.e., 60% of the unclassified documents is identified to contain PII) of those unclassified documents that contain PII, then data classifier program 122 remediates the entire grouping of unclassified documents from the cloud-based system.

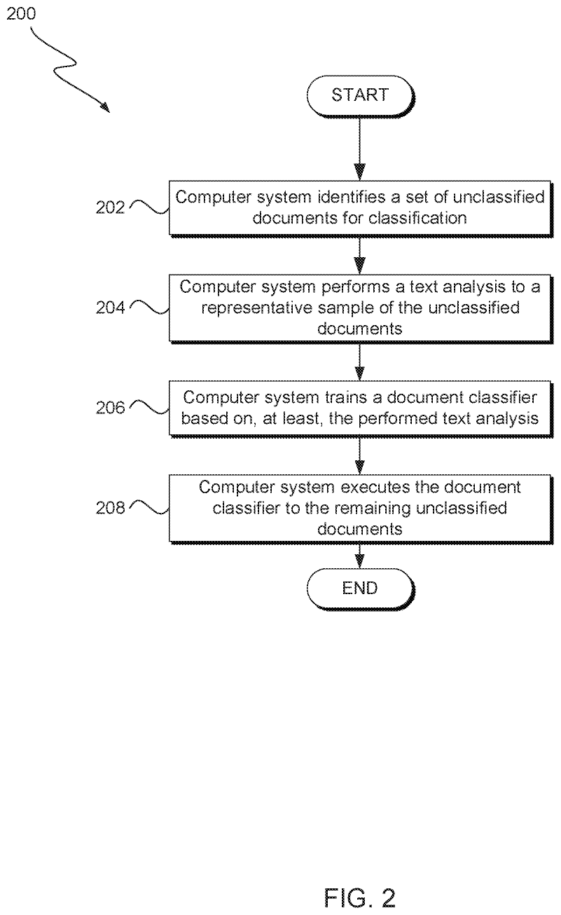

FIG. 2 is a flowchart, 200, depicting operations of data classifier program 122 in computing environment 100, in accordance with an illustrative embodiment of the present invention. FIG. 2 also represents certain interactions between data classifier program 122 and client application 132. In some embodiments, the operations depicted in FIG. 2 incorporate the output of certain logical operations of data classifier program 122 executing on computer system 120. It should be appreciated that FIG. 2 provides an illustration of one implementation and does not imply any limitations with regard to the environments in which different embodiments may be implemented. Many modifications to the depicted environment may be made. In one embodiments, the series of operations in FIG. 2 can be performed in any order. In another embodiment, the series of operations, depicted in FIG. 2, can be performed simultaneously. Additionally, the series of operations, depicted in FIG. 2, can be terminated at any operation. In addition to the features previously mentioned, any operations, depicted in FIG. 2, can be resumed at any time.

In operation 202, data classifier program 122 identifies a set of unclassified documents for classification. In various embodiments, data classifier program 122 receives a data classifier request, from client device 130, to search for personal identifying information (PII) contained within unclassified documents stored on database 144. Embodiments of the present invention recognize that analyzing the entirety of the unclassified documents stored on the cloud-based system is a cumbersome load on the server and system and is an inefficient use of time. As such, in various embodiments, the data classifier request defines a threshold number of a first subset of the unclassified documents for which a full text analysis should be performed. Then, as will be discussed below in the context of subsequent operations, data classifier program 122 uses the full text analysis of the first subset to train a document classifier (e.g., using cognitive AI) to identify PII within the remaining documents of the unclassified documents (a “second subset”). In various embodiments, data classifier program 122 accesses database 144 and retrieves the first subset of the unclassified documents stored on database 144.

In operation 204, data classifier program 122 performs a text analysis of the first subset of the unclassified documents. In this operation, data classifier program 122 determines whether documents of the first subset include PII based on, at least, the actual text of the documents of the first subset (as opposed to based only on the metadata of the documents). Embodiments of the present invention recognize that text analysis represents program code including, but not limited to, (i) natural language processing (NLP), (ii) supervised manual inspection, and/or (iii) programmatic identification of document features. In various embodiments, data classifier program 122 identifies classes for each processed document. In various embodiments, the classes for each processed document include, but are not limited to, (i) contain PII, (ii) do not contain PII, (iii) human resources (HR) data, (iv) patient health data, (v) payment history data, and (vi) individual contact information. In various embodiments, data classifier program 122 stores the classes of each processed document on database 144 for subsequent use and review.

In various embodiments, data classifier program 122 identifies the metadata associated with the first subset of the unclassified documents after performing a full-text analysis of the first subset of the unclassified documents. For example, as previously discussed, the metadata may include (i) pre-existing document metadata (e.g., owner, file type, source, folder, etc.) and (ii) derived metadata (e.g., department of the document owner, country of origin, etc.).

In operation 206, data classifier program 122 trains a document classifier based on, at least, the performed text analysis. In various embodiments, data classifier program 122 trains the document classifier to determine which documents contain PII (and thus, are non-compliant) based on, at least, (i) the classes identified in the text analysis of the first subset of documents and (ii) the metadata of the documents of the first subset. Stated another way, in this operation, data classifier program 122 trains the document classifier to classify documents as having PII (i.e., non-compliant) or not having PII (i.e., compliant) based only on their metadata. For example, when the classes identified in the full text analysis include “contains PII” and “does not contain PII,” data classifier program 122 can use those classes, in combination with the metadata of the first subset, to train the document classifier (via backpropagation, for example) to generate those classes as output based on input metadata. Embodiments of the present invention recognize that training the document classifier in this way will allow data classifier program 122 to identify unclassified documents within the second subset based on only the metadata of the second subset, as opposed to the full text of the second subset.

In various embodiments, data classifier program 122 trains the data classifier iteratively (i.e., over multiple iterations). In various embodiments, data classifier program 122 runs a new in-depth text analysis (e.g., using natural language processing) of a new first subset of unclassified documents and also executes the document classifier on the new first subset. In various embodiments, data classifier program 122 selects a pseudo-random subset of unclassified documents for the new first subset from the remaining unclassified documents. For example, using the example discussed above, the new first subset is selected from the remaining 19,999,000 unclassified documents, which is the original 20,000,000 unclassified documents minus the 1,000 documents from the original first subset. In various embodiments, data classifier program 122 performs a full-text analysis and identifies various documents within the new first subset that contain PII. In various embodiments, data classifier program 122 also classifies the various documents within the new first subset based on, at least, their metadata. Data classifier program 122 then compares the results of the document classifier against the new in-depth text analysis. In various embodiments, data classifier program 122 calculates the precision and/or recall of the document classifier based on, at least, the assumption that the new in-depth text analysis produced results of 100% accuracy (or close to 100% accuracy). In various embodiments, data classifier program 122 continues the iterative process—including selecting a new first subset, performing a full text analysis, and comparing the results to results generated by the trained document classifier—until an exit criterion has been reached (e.g., where no significant improvement in the precision/recall has occurred, or where the process has reached a maximum number of iterative cycles). Embodiments of the present invention provide that iterative processes of the in-depth text analysis are analyzed and the results of the classifications based on, at least, the metadata of the unclassified documents from subsequent iterative processes are compared against the previous in-depth text analysis as a quality assurance check to ensure that the classifications based on, at least, the metadata of the unclassified documents was performed accurately. If the exit criterion has not yet been reached, data classifier program 122 further trains the document classifier using the results of the full text analysis of the new first subset (more specifically, the identified classes), and the iterative process starts over with the selection of an additional new first subset of unclassified documents.

In various embodiments, data classifier program 122 calculates the quality of the document classifier after one or more iterations of the iterative process. In various embodiments, data classifier program 122 calculates the quality of the data classifier utilizing, at least, the precision and recall of the data classifier based on, but not limited to, the assumption that the text analysis of the unclassified documents was initially correct. In various embodiments, data classifier program 122 exits the backpropagation of training the data classifier if an exit criterion is met. In various embodiments, the exit criterion is met if at least one of the following is established: (i) a precision threshold, (ii) a recall threshold, and (iii) a maximum number of iterations of backpropagation.

In operation 208, data classifier program 122 executes the document classifier on the remaining unclassified documents (i.e., on the second subset). Embodiments of the present invention provide that the second subset of the unclassified documents represents all of the unclassified documents minus the first subset and the new first subset(s) used for the full-text analysis for training the data classifier. In various embodiments, the data classifier analyzes the metadata of each document within the second subset of the unclassified documents. In various embodiments, the fully trained data classifier identifies documents within the second subset of the unclassified documents that contain PII based on only the metadata, where the data classifier identifies PII based on the classifications established through the full-text analysis when the data classifier was being trained. In various embodiments, at the conclusion of analyzing the metadata of the second subset of the unclassified documents, data classifier program 122 executes program instructions instructing database 144 to remediate database 144 of all the identified documents that contain PII. In alternative embodiments, data classifier program 122 includes program instructions that instruct database 144 to remediate documents of a similar class (e.g., similar metadata that includes, but is not limited to, department of the document owner and country of origin) at a threshold level of identified documents within the class (e.g., 60% of the documents within a class have been identified to contain PII, then the entirety of the class of those unclassified documents are remediated from the database). Embodiments of the present invention provide that at the conclusion of the analysis of the second subset of the unclassified documents, data classifier program 122 generates a report indicating all of the documents from the unclassified documents that were remediated from database 144.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

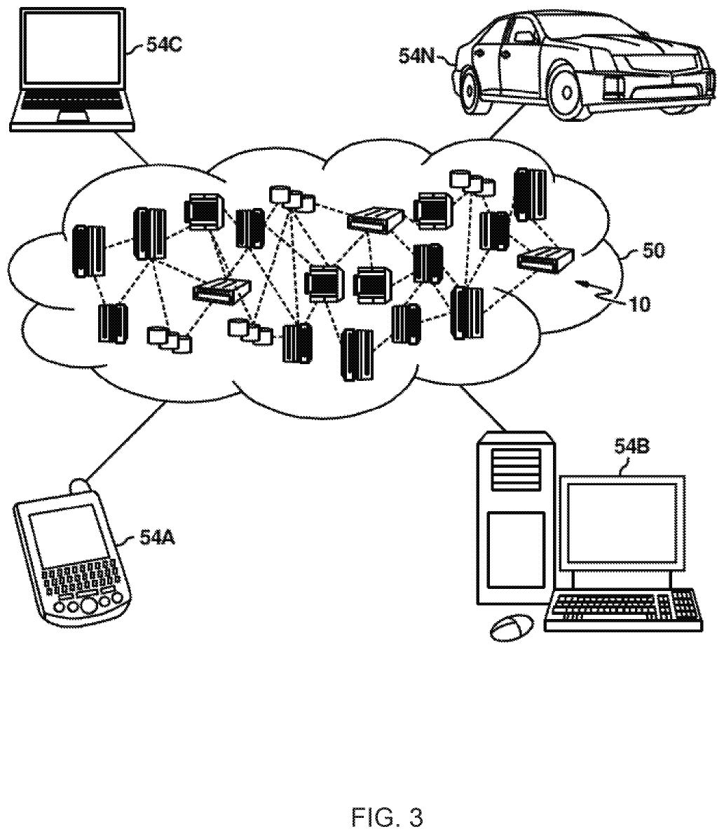

Referring now to FIG. 3, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

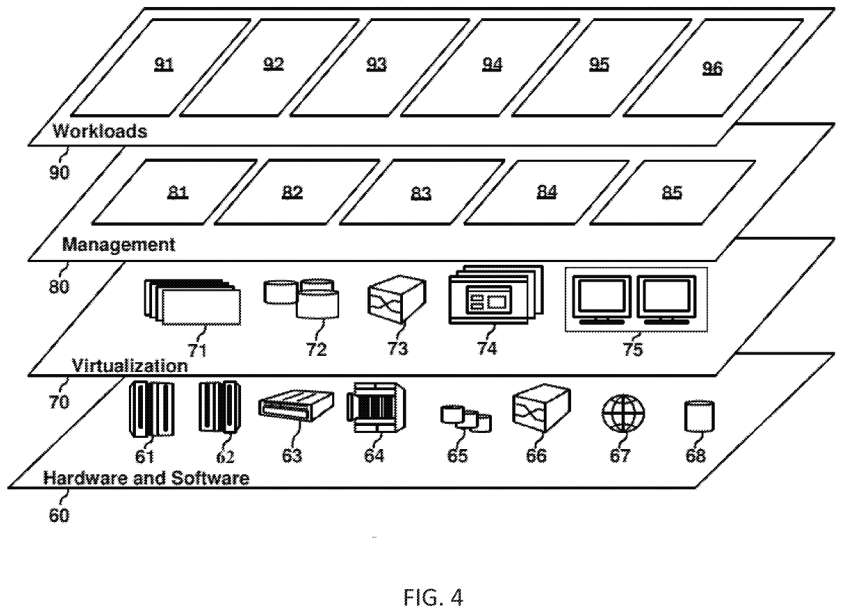

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and providing soothing output 96.

FIG. 5 depicts a block diagram, 500, of components of computer system 120, client device 130, and SAN 140, in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Computing system 120, client device 130, and storage area network (SAN) 140 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Data classifier program 122, computer interface 124, client application 132, client interface 134, server application 142, and database 144 are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices, including resources of network 110. In these examples, communications unit 510 includes one or more network interface cards. Communications unit 510 may provide communications through the use of either or both physical and wireless communications links. Data classifier program 122, computer interface 124, client application 132, client interface 134, server application 142, and database 144 may be downloaded to persistent storage 508 through communications unit 510.

I/O interface(s) 512 allows for input and output of data with other devices that may be connected to computing system 120, client device 130, and SAN 140. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., data classifier program 122, computer interface 124, client application 132, client interface 134, server application 142, and database 144, can be stored on such portable computer-readable storage media and can be loaded onto persistent storage 508 via I/O interface(s) 512. I/O interface(s) 512 also connect to a display 520.

Display 520 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

It is to be noted that the term(s) such as, for example, “Smalltalk” and the like may be subject to trademark rights in various jurisdictions throughout the world and are used here only in reference to the products or services properly denominated by the marks to the extent that such trademark rights may exist.

What is claimed is:

1. A computer-implemented method, the method comprising:
identifying, by one or more processors, a set of documents for classification;
classifying, by one or more processors, documents of a first subset of the set of documents based, at least in part, on a text analysis of the documents of the first subset;
training, by one or more processors, a document classifier using, as training data: (i) results of the classifying of the documents of the first subset, and (ii) metadata associated with the documents of the first subset; and
classifying, by one or more processors, documents of a second subset of the set of documents by providing metadata of the documents of the second subset to the trained document classifier.

2. The computer-implemented method of claim 1, further comprising:
further classifying, by one or more processors, the documents of the second subset based, at least in part, on a text analysis of the documents of the second subset;
comparing, by one or more processors, results of the classifying of the documents of the second subset and results of the further classifying of the documents of the second subset; and
further training, by one or more processors, the document classifier based, at least in part, on the comparing.

3. The computer-implemented method of claim 2, further comprising:
determining, by one or more processors, whether an exit criterion for training the document classifier has been met.

4. The computer-implemented method of claim 3, further comprising:
in response to determining that that the exit criterion has been met, classifying, by one or more processors, the remaining documents of the set of documents by providing metadata of the remaining documents to the further trained document classifier.

5. The computer-implemented method of claim 3, further comprising:
in response to determining that the exit criterion has not been met:
classifying, by one or more processors, documents of a third subset of the set of documents by providing metadata of the documents of the third subset to the further trained document classifier;
further classifying, by one or more processors, the documents of the third subset based, at least in part, on a text analysis of the documents of the third subset;
comparing, by one or more processors, results of the classifying of the documents of the third subset and results of the further classifying of the documents of the third subset; and
further training, by one or more processors, the document classifier based, at least in part, on the comparing of the results of the classifying of the documents of the third subset and the results of the further classifying of the documents of the third subset.

6. The computer-implemented method of claim 1, wherein the trained document classifier classifies one or more documents of the set of documents as non-compliant.

7. The computer-implemented method of claim 6, further comprising:
remediating, by one or more processors, the one or more documents classified as non-compliant by: (i) purging the one or more documents classified as non-compliant from the set of documents, (ii) storing the one or more documents classified as non-compliant to a different location than the set of documents, and (iii) informing owners of the one or more documents classified as non-compliant that the owners own a non-compliant document.

8. A computer program product, the computer program product comprising:
one or more computer-readable storage media and program instructions stored on the one or more computer-readable storage media, the stored program instructions comprising:
program instructions to identify a set of documents for classification;
program instructions to classify documents of a first subset of the set of documents based, at least in part, on a text analysis of the documents of the first subset;
program instructions to train a document classifier using, as training data: (i) results of the classifying of the documents of the first subset, and (ii) metadata associated with the documents of the first subset; and
program instructions to classify documents of a second subset of the set of documents by providing metadata of the documents of the second subset to the trained document classifier.

9. The computer program product of claim 8, the stored program instructions further comprising:
program instructions to further classify the documents of the second subset based, at least in part, on a text analysis of the documents of the second subset;
program instructions to compare results of the classifying of the documents of the second subset and results of the further classifying of the documents of the second subset; and
program instructions to further train the document classifier based, at least in part, on the comparing.

10. The computer program product of claim 9, the stored program instructions further comprising:
program instructions to determine whether an exit criterion for training the document classifier has been met.

11. The computer program product of claim 10, the stored program instructions further comprising:
program instructions to classify the remaining documents of the set of documents by providing metadata of the remaining documents to the further trained document classifier, in response to determining that the exit criterion has been met.

12. The computer program product of claim 10, the stored program instructions further comprising:
program instructions to, in response to determining that the exit criterion has not been met:
classify documents of a third subset of the set of documents by providing metadata of the documents of the third subset to the further trained document classifier;
further classify the documents of the third subset based, at least in part, on a text analysis of the documents of the third subset;
compare results of the classifying of the documents of the third subset and results of the further classifying of the documents of the third subset; and
further train the document classifier based, at least in part, on the comparing of the results of the classifying of the documents of the third subset and the results of the further classifying of the documents of the third subset.

13. The computer program product of claim 8, wherein the trained document classifier classifies one or more documents of the set of documents as non-compliant.

14. The computer program product of claim 13, the stored program instructions further comprising:
program instructions to remediate the one or more documents classified as non-compliant by: (i) purging the one or more documents classified as non-compliant from the set of documents, (ii) storing the one or more documents classified as non-compliant to a different location than the set of documents, and (iii) informing owners of the one or more documents classified as non-compliant that the owners own a non-compliant document.

15. A computer system, the computer system comprising:
one or more computer processors;
one or more computer readable storage medium; and
program instructions stored on the computer readable storage medium for execution by at least one of the one or more processors, the stored program instructions comprising:
program instructions to identify a set of documents for classification;
program instructions to classify documents of a first subset of the set of documents based, at least in part, on a text analysis of the documents of the first subset;
program instructions to train a document classifier using, as training data: (i) results of the classifying of the documents of the first subset, and (ii) metadata associated with the documents of the first subset; and
program instructions to classify documents of a second subset of the set of documents by providing metadata of the documents of the second subset to the trained document classifier.

16. The computer system of claim 15, the stored program instructions further comprising:
program instructions to further classify the documents of the second subset based, at least in part, on a text analysis of the documents of the second subset;
program instructions to compare results of the classifying of the documents of the second subset and results of the further classifying of the documents of the second subset; and
program instructions to further train the document classifier based, at least in part, on the comparing.

17. The computer system of claim 16, the stored program instructions further comprising:
program instructions to determine whether an exit criterion for training the document classifier has been met.

18. The computer system of claim 17, the stored program instructions further comprising:
program instructions to classify the remaining documents of the set of documents by providing metadata of the remaining documents to the further trained document classifier, in response to determining that the exit criterion has been met.

19. The computer system of claim 17, the stored program instructions further comprising:
program instructions to, in response to determining that the exit criterion has not been met:
classify documents of a third subset of the set of documents by providing metadata of the documents of the third subset to the further trained document classifier;
further classify the documents of the third subset based, at least in part, on a text analysis of the documents of the third subset;
compare results of the classifying of the documents of the third subset and results of the further classifying of the documents of the third subset; and
further train the document classifier based, at least in part, on the comparing of the results of the classifying of the documents of the third subset and the results of the further classifying of the documents of the third subset.

20. The computer system of claim 15, wherein the trained document classifier classifies one or more documents of the set of documents as non-compliant.
